(19) United States
(12) Patent Application Publication
(10) Pub. No.: US 2010/0228984 A1
(43) Pub. Date: Sep. 9, 2010

(54) FULL-RIGHTS LOCAL PLAYBACK OF DIGITAL CONTENT

(75) Inventors: Thomas Michael Soemo, Redmond, WA (US); Paul Stephen Hellyar, Redmond, WA (US); Adam Poulos, Bothell, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/397,216

(22) Filed: Mar. 3, 2009

(51) Int. Cl. H04L 9/32; H04L 9/30

(52) U.S. Cl. 713/176

(57) ABSTRACT

A method of playing a digital content item includes downloading the digital content item from a removable data-holding medium to a local data-holding medium of a media playing system, and sending a licensing request to a network-accessible, digital-content service. The method further includes receiving a full-rights license for the digital content item from the digital-content service, where the full-rights license grants a right to play the digital content item from the local data-holding medium of the media playing system without the removable data-holding medium being present. The method further includes receiving a request to play the digital content item, and verifying the full-rights license for the digital content item. The method further includes playing the digital content item from the local data-holding medium if the full-rights license verifies, without the removable data-holding medium being present.

### BACKGROUND

Digital content items such as digital audio, digital video, digital images, games, and the like are often stored on removable data-holding media, such as compact discs, DVDs, or game discs. In such a case, digital content items can then be played from the disc via a computing device including a disc drive configured to read the disc. When a disc is rendered unplayable, for example due to scratches, damage or loss, it is advantageous to have a copy of the digital content item on a local data-holding medium, such as a hard drive of a computing system.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Various embodiments related to full-rights local playback are discussed herein. One disclosed embodiment includes making full-rights local playback of a digital content item contingent on the availability of a full-rights license granting the right to play media locally when a removable medium is not present.

### BRIEF DESCRIPTION OF THE DRAWINGS

FIG. 1 shows a flow diagram of an example method of downloading a digital content item from a removable data-holding medium onto a local data-holding medium.

FIG. 2 shows a flow diagram of an example method of obtaining a full-rights license.

FIG. 3 shows a flow diagram of an example method of obtaining a limited-rights license.

FIG. 4 shows a flow diagram of an example method of playing a digital content item from a local data-holding medium.

FIG. 5 shows an embodiment of a gaming system.

### DETAILED DESCRIPTION

The present disclosure is directed to playing a digital content item from a local data-holding medium (e.g., hard drive), where the digital content item has been downloaded to the local data-holding medium from a removable data-holding medium (e.g., disc), and the presence of the removable data-holding medium is not necessary for playing the digital content item from the local data-holding medium. Digital content items may include, for example, digital audio, digital video, digital images, games, and the like. In particular, such an approach may be utilized for playing an electronic game on a gaming console, and may contribute to a more positive game-playing experience for the game user, as described below.

While the below examples are described with reference to digital content in the form of digital games, removable data-holding media in the form of game discs, and local data-holding media in the form of game console hard drives, it is to be understood that such examples are not limiting. The concepts described below can be applied to virtually any type of digital content downloaded from virtually any type of removable data-holding media to virtually any type of local data-holding media without departing from the scope of this disclosure.

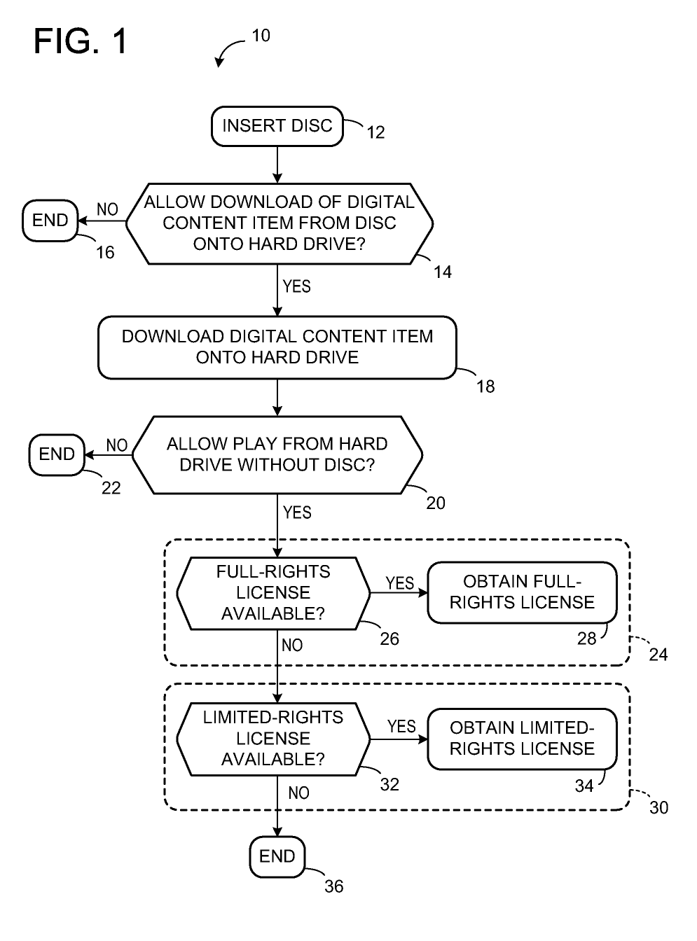

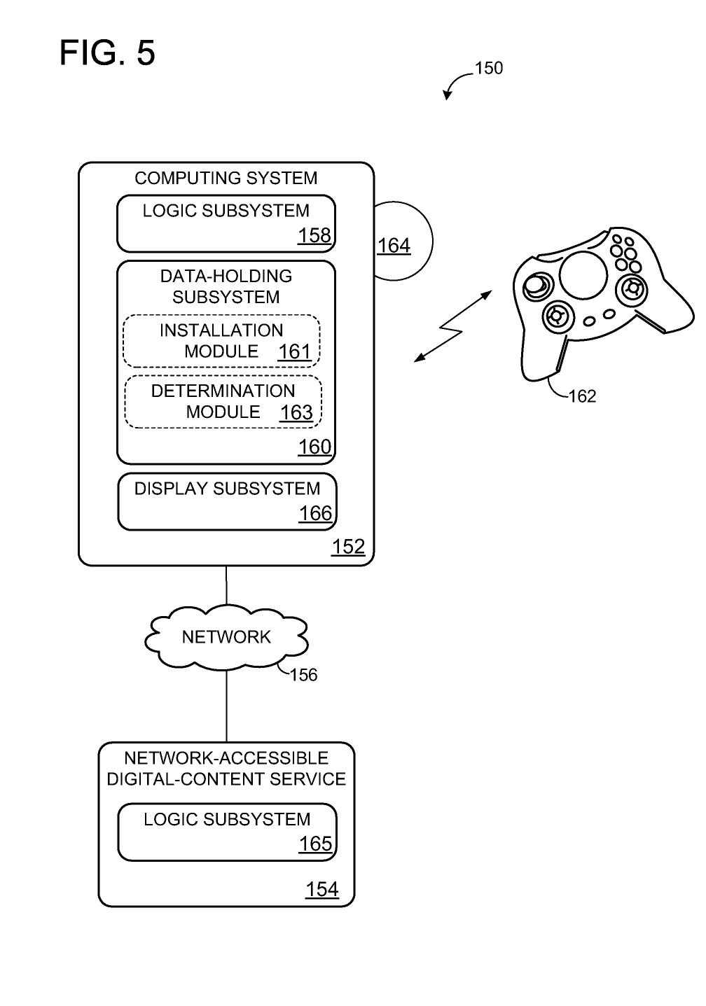

FIG. 1 shows a flow diagram of an example method 10 of downloading a digital content item from a removable data-holding medium onto a local data-holding medium. At 12, method 10 includes inserting a disc into a game-playing device. The disc is a nonlimiting example of a removable data-holding medium, such as a DVD or game disc, upon which a digital content item (e.g., game) is stored. The game-playing device is a nonlimiting example of a computing system comprising a local data-holding medium. Other computing systems may be used, as described with reference to FIG. 5.

At 14, method 10 includes determining whether the game on the game disc may be downloaded to the hard drive of the game-playing device.

If it is determined that downloading the game to the hard drive is not allowed, then at 16 method 10 includes ending the installation process. In such a case, the game may only be played directly from the disc without first being downloaded onto the hard drive.

If it is determined that downloading the game to the hard drive is allowed, at 18 method 10 includes downloading the game onto the hard drive. In some cases, a logic subsystem such as logic subsystem 158 of computing device 152 shown in FIG. 5 may be configured to download the game onto a hard drive such as data-holding subsystem 160 using installation module 161. Downloading a game to the hard drive affords potential advantages to the user. Previous game-playing approaches requiring the user to play the game directly from the game disc, rather than the hard drive, may cause the user to experience slow load times while data is being read from the disc. Additionally, the spinning and reading of the game disc in an optical drive of a game-playing device may create noise that the user finds distracting during the gaming experience. Thus, by downloading the game to the hard drive, the user may have an uninterrupted, quieter gaming experience. Furthermore, the ability to play a game from the hard drive may also increase gamer convenience. If games are only played directly from game discs, a gamer must switch game discs each time the gamer plays a different game. The ability to play games from the hard drive allows a gamer to play a different game without inserting a different game disc into the game-playing device before the gaming session.

At 20, method 10 includes determining whether the game may be played from the hard drive without the presence of the game disc. In some cases, a determination module such as determination module 163 of computing system 152 shown in FIG. 5 may perform step 20 of method 10. Thus, whereas previous game-playing approaches require the game disc to be in the disc drive when playing the game from the hard drive, method 10 may offer the potential advantage of not requiring the presence of the game disc. In such an approach, a user may then have the convenience of switching to play another game from the hard drive without having to get up, locate another game disc, and insert it into their game-paying device. Further, by not requiring the game disc once the game has been installed to the hard drive, the user may maximize the lifetime of their games by having the ability to still play the games downloaded to their hard drive even if the disc becomes scratched, damaged or lost.

If it is determined that the game is not allowed to be played from the hard drive without the presence of the game disc, then at 22 method 10 includes ending the installation process. As an example, an installation module such as installation module 161 of computing system 152 shown in FIG. 5 may end the installation process. In such a case, the game may only be played directly from the disc without first being downloaded onto the hard drive.

Oftentimes a digital content item may be protected by digital rights management which provides restrictions and/or policies regarding the use of the digital content item. In some cases, digital rights management may be used to allow for secure delivery of the digital content item for playback on computers, portable devices, and network devices. In some cases digital rights management may be used to restrict unauthorized copying of the digital content item. Further, in some cases digital rights management may include requiring a license agreement to identify how and/or when the digital content item may be used.

In the context of game-playing as discussed above, digital rights management may be applied to playing a game from the hard drive without a disc. For example, upon downloading the game to the hard drive, a user may need to first obtain a license from a licensing service associated with the game before the user is allowed to play the game from the hard drive. Such a license may define the circumstances under which the game may be played from the hard drive. For example, the license might specify that only one instance of the game may be downloaded and played. In another example, the license may specify a fixed-duration time period during which the game may be played from the hard drive. Further, the digital content item may be protected in such a way, for example, that only one license may be granted per game per user.

A computing system may be configured to make game play from the hard drive, or other local data-holding medium, contingent on the existence of a valid license that grants the rights for such play. In some cases a developer of the computing system configured to play the game may indicate availability of such a license. In other cases, the software on the computing system may indicate availability of such a license. As described by way of example below, such licenses may include full-rights licenses and/or limited-rights licenses, which may be applied to different circumstances. As part of this licensing scheme, method 10 optionally includes obtaining licensing as indicated by the dashed boxes 24 and 30, and described as follows.

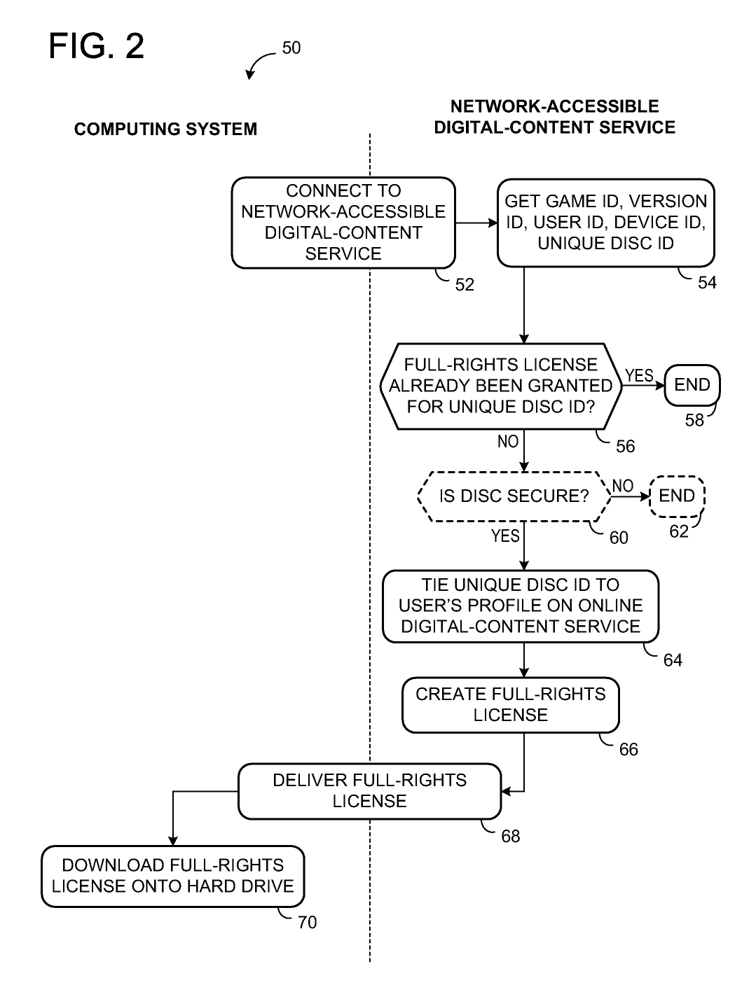

If the game is allowed to be played from the hard drive without the presence of the game disc, then at 26 method 10 may optionally include determining if a full-rights license is available. The full-rights license may grant the user a right to play the game from the hard drive of the game-playing device without the game disc being present. Availability of the full-rights license may be based on several conditions, as described in more detail with reference to FIG. 2. If the full-rights license is available, then at 28 method 10 includes obtaining the full-rights license. The full-rights license may be obtained from a network-accessible digital-content service. As an example, such a digital-content service may be a gaming service as described in more detail with reference to FIG. 2.

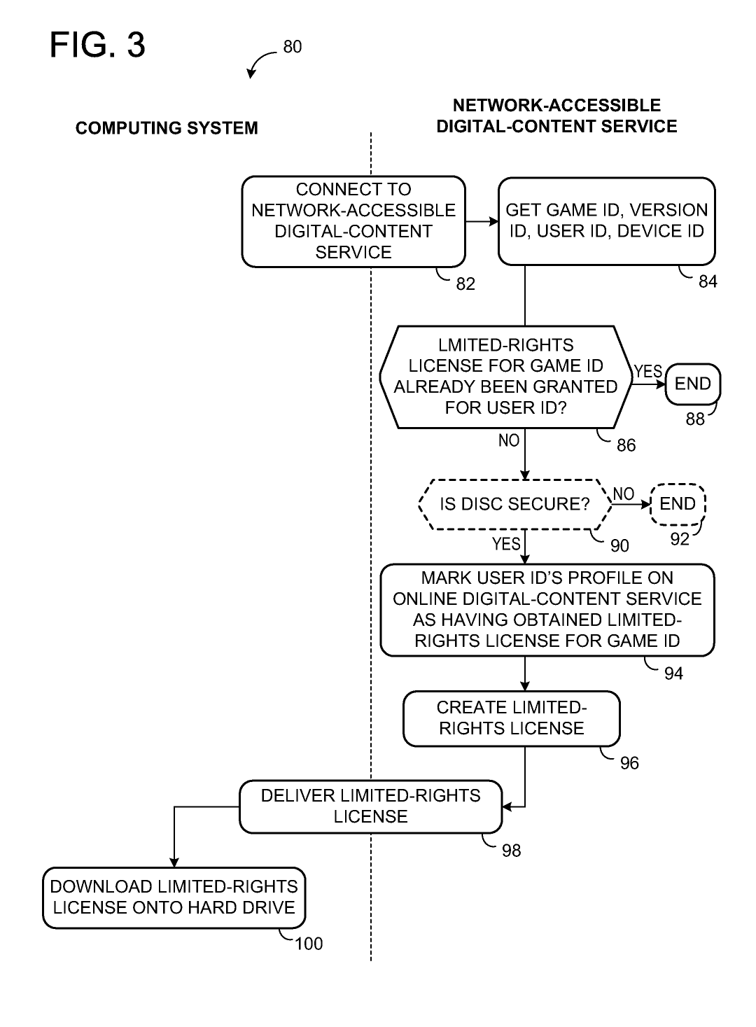

At 32 method 10 may optionally include determining if a limited-rights license, such as a demo license or a rental license, is available. The limited-rights license may grant the user a right to play the game from the hard drive of the game-playing device without the game disc being present under one or more conditions, such as during a fixed-duration trial period. Availability of the limited-rights license may be based on several conditions, as described in more detail with reference to FIG. 3.

If the limited-rights license is available, then at 34 method 10 includes obtaining the limited-rights license. The limited-rights license may be obtained from a network-accessible digital-content service, as described in more detail in the description of FIG. 3.

As described above, method 10 may be designed for full-rights licensing, as generally indicated at dashed box 24, and/or limited-rights licensing, as generally indicated at dashed box 30. It is to be understood that full-rights licensing may be offered without limited-rights licensing, or vice versa. It is also to be understood that provisions for both full-rights licensing and limited-rights licensing may be implemented in some embodiments.

If neither a full-rights license nor a limited-rights license is available, then at 36 method 10 includes ending the installation process. In such a case, the game may be played directly from the disc without first being downloaded onto the hard drive.

As shown at dashed boxes 24 and 30 in FIG. 1, in order for a digital content item downloaded from a removable-storage medium onto a local storage medium to be played from the local storage medium without a disc, a user may need to obtain a license from a network-accessible digital-content service. FIGS. 2 and 3 show flow diagrams of exemplary methods for obtaining full-rights and limited-rights licenses, respectively, and these figures are described in more detail as follows. It is to be understood that the methods described with reference to FIGS. 2 and 3 are nonlimiting.

FIG. 2 shows a flow diagram of an example method 50 of obtaining a full-rights license. At 52 method 50 includes connecting to a network-accessible digital-content service. In some cases, a user of a computing system may request to connect to the digital-content service. In some cases, the computing system may automatically connect to the digital-content service.

In the context of the game-playing example described above with reference to FIG. 1, such a network-accessible digital-content service may be accessible via the Internet, such as an online gaming service. In some cases the network-accessible digital-content service may be a media provider accessible through a local network or intranet. In some cases, the network-accessible digital-content service may function as a digital content item delivery service that allows a user to set up an account on the network-accessible digital-content service and purchase digital content items from the service to be downloaded over a network. In some cases, the network-accessible digital-content service may offer social media experiences, such as sharing digital content via social-networking, and/or in the context of game-playing, allow multiple users to play a game together.

Connecting to the digital-content service may include the computing system submitting a licensing request to the digital-content service. In the context of the game-playing example, the computing system may be a game-playing device onto which a game was downloaded from a game disc, utilizing an installation process such as method 10 shown in FIG. 1. Upon downloading the game to the game-playing device, the game-playing device may send a licensing request including information identifying a user of the game-playing device, the game, and the game disc from which the game was downloaded. As an example, the licensing request may include a user ID identifying a user of the game-playing device, a device ID identifying the game-playing device, and a game ID identifying the game. The licensing request may further include a version ID identifying a particular version of the game, and a unique disc ID identifying the game disc. The unique disc ID allows for the digital-content service to uniquely identify the specific physical game disc from which the game was downloaded, since each game disc has a unique disc ID different from other unique disc IDs of other game discs. In some cases, the unique disc ID may be on the game disc itself, and the game-playing device may be further configured to automatically read the unique disc ID off of the game disc. Such a unique disc ID may be different from the data stamped onto the disc. For example, the unique disc ID may be a printed barcode that is separate from the stamping process to ensure that discs may be economically stamped while still including unique disc IDs to differentiate each disc from the other discs.

At 54 method 50 includes the digital-content service receiving such identification information from the game-playing device. Upon receiving the identification information, at 56 method 50 includes the digital-content service determining if a full-rights license has already been granted for the unique disc ID. For example, each game disc may allow one full-rights license to be granted. Therefore, the digital-content service may perform an availability check to see if a full-rights license has already been granted for that particular unique disc ID. In some cases, a logic subsystem such as logic subsystem 165 of network-accessible digital-content service 154 shown in FIG. 5 may perform step 56 of method 50. In the case that the full-rights license has already been granted, then at 58 method 50 includes ending the licensing process.

If it is determined that a full-rights license has not already been granted for that particular unique disc ID, then the digital-content service may optionally determine if the disc is secure as indicated at 60 of method 50. Such a step may include a security check to determine if the game is “secure” in that it has not been altered and/or modified. As an example, non-secure discs may have been altered by a user to include modifications to the game code and/or data to achieve an unfair advantage to the user. Such non-secure discs may be deemed ineligible for full-rights licensing as described herein. In some cases, a logic subsystem such as logic subsystem 165 of network-accessible digital-content service 154 shown in FIG. 5 may perform the security check.

Any suitable approach may be used for performing such a security check. One approach includes obtaining a root hash of the game from the licensing request submitted by the game-playing device. In such a case, upon loading the game onto the hard drive of the game-playing device, the root hash may be hashed by employing a hashing algorithm utilizing a tree approach which breaks the game up into several pieces, and iteratively hashes, combines and rehashes the pieces in a tree-like fashion until a single “root hash” is created. In some cases, the root hash may be a small number of bytes and therefore easily included on a licensing request submitted to the digital-content service.

The digital-content service can then access a known root hash generated from a secure version of the game, where the known root hash identifies the original (i.e. “secure”) contents of the game. In some cases, the digital-content service may obtain the known root hash based on the version ID of the game. The digital-content service may then compare the root hash with the known root hash.

If the security check yields a root hash that is not equivalent to the known root hash, then the game is not secure, and the licensing process ends as shown at 62 of method 50.

However, if the security check verifies equivalence of the root hash hashed from the game on the hard drive of the game-playing device and the known root hash, then the game is secure and the licensing process may continue as follows.

At 64 method 60 includes documenting that the full-rights license is being granted for the unique disc ID. Such a step may include tying a user's profile on the digital-content service to the unique disc ID. Such documentation may be utilized by the digital-content service when determining if a full-rights license has already been granted for the unique disc ID, such as at step 56 of method 50.

At 66 method 50 includes the digital-content service creating the full-rights license, the full-rights license granting the user a right to play the game from the hard drive of the game-playing device without the game disc being present. In such a case, the game-playing device may be configured to search for such a license upon obtaining a request to play the game from the hard drive when a disc is not present, and only allow the game to be played if a valid license has been obtained. For example, the license may be downloaded and stored on the user's game-playing device which has been manufactured and/or programmed to search for such a license, and only allow playing the game from the hard drive without the disc if a valid license for the game exists on the game-playing device. Such a licensing scenario ensures that parameters regarding the option of playing the game from the hard drive without the presence of a game disc are defined and controlled, and utilizing such a feature when playing the game is contingent upon having a valid license.

In some cases, the full-rights license may be digitally signed by the digital-content service with a digital signature. The digital signature may be encrypted with a private key corresponding to the digital-content service. Digitally signing the license may prevent unauthorized copying and/or distributing of the license. Additionally, game-playing devices obtaining digitally signed licenses may decrypt the license before utilizing the license as a part of game play. For example, the game-playing device may be manufactured and/or configured to include a public key corresponding to the private key of the digital-content service, and the game-playing device may then use the public key to decrypt an encrypted digital signature of a received license.

At 68 method 50 includes delivering the full-rights license to the game-playing device. At 70 method 50 includes downloading the full-rights license onto the hard drive of the game-playing device.

FIG. 3 shows a flow diagram of an example method of obtaining a limited-rights license. For example, the limited-rights license may be a demonstration license allowing the user to preview the game for a fixed-length period of time, such as in the case of renting a game from a rental service. In another example, a user may give his game to a friend to borrow, and the friend may obtain a limited-rights license. Upon obtaining the limited-rights license the friend may play the game from the hard drive of her game-playing device contingent on one or more conditions being satisfied (e.g., for a set number of days), even if she has returned the game disc to the user.

At 82 method 80 includes connecting to a network-accessible digital-content service. As described above with reference to FIG.2, connecting to the digital-content service may include the computing system submitting a licensing request to the digital-content service. In the context of the game-playing example described thus far, the computing system may be a game-playing device onto which a digital-content item (e.g., game) was downloaded from a removable data-holding medium (e.g., game disc), utilizing an installation process such as method 10 shown in FIG. 1. Upon downloading the game to the game-playing device, the game-playing device may send a licensing request including information identifying a user of the game-playing device, the game, and the game disc from which the game was downloaded. As an example, the licensing request may include a user ID identifying a user of the game-playing device, a device ID identifying the game-playing device, and a game ID identifying the game. The licensing request may further include a version ID identifying a particular version of the game. Such a version ID may indicate a release version of the game, wherein each release version of a game may have code modifications in comparison to previously released versions of the game, where the code modifications may be adding features, improving performance, fixing bugs, etc.

At 84 method 80 includes the digital-content service receiving such identification information. Upon receiving the identification information, at 86 method 80 includes the digital-content service determining if a limited-rights license has already been granted for the game. For example, each game may allow one limited-rights license per user. Therefore, the digital-content service may perform an availability check to see if a limited-rights license has already been granted for that game to the user. In some cases, a logic subsystem such as logic subsystem 165 of network-accessible digital-content service 154 shown in FIG. 5 may perform such an availability check. In some embodiments, method 80 may include determining if the limited-rights license has already been granted based on the user ID and the game ID. As described above, a game may exist in multiple versions. Thus, licensing availability may be based on game ID rather than version ID. For example, a Game X may allow one demo license per user so that the user may demo the game during a trial period. User Y may have already obtained a demo license for Game X version 1.1.1.1, and may attempt to demo Game X version 1.1.1.2. Upon submitting a request to obtain another demo license, a gaming service may perform an availability check and determines that User Y has previously obtained a demo license for Game X and is not eligible to obtain another one, thus ensuring User Y is only allowed to demo Game X once.

In the case that the limited-rights license has already been granted, then at 88 method 80 includes ending the licensing process.

If it is determined that a limited-rights license has not already been granted, then the digital-content service may optionally determine if the disc is secure as indicated at 90 of method 80. In some cases, a logic subsystem such as logic subsystem 165 of network-accessible digital-content service 154 shown in FIG. 5 may perform the security check. Such a security check may be similar to that described above in the context of FIG. 2, where a root hash of the game is obtained from the licensing request submitted by the game-playing device and compared with a known root hash generated from a secure version of the game. If the security check yields a root hash that is not equivalent to the known root hash, then the game is not secure, and the licensing process ends as shown at 92 of method 80.

However, if the security check verifies equivalence of the root hash hashed from the game on the hard drive of the game-playing device and the known root hash, then the game is secure and the licensing process may continue as follows.

At 94 method 80 includes documenting that the limited-rights license for the game is being granted to the user. Such a step may include tying a user's profile on the digital-content service to the game ID. Such documentation may be utilized by the digital-content service when determining if a limited-rights license has already been granted for the game ID, such as at step 86 of method 80.

At 96 method 80 includes the digital-content service creating the limited-rights license, the limited-rights license granting the user a right to play the game from the hard drive of the game-playing device without the game disc being present under one or more conditions, such as during a fixed-duration trial period.

As described above with reference to FIG. 2, a game-playing device may be configured to search for such a license upon obtaining a request to play the game from the hard drive when a disc is not present, and only allow the game to be played if a valid license is obtained. For example, the license may be downloaded and stored on the user's game-playing device which has been manufactured and/or programmed to search for such a license, and only allow the playing the game from the hard drive without the disc if a valid license for the game exists on the game-playing device. Such a licensing scenario ensures that conditions under which the limited-rights license allows playing the game from the hard drive without the presence of a game disc are met, and utilizing such a feature when playing the game is contingent upon having a valid license.

In some cases, the limited-rights license may be digitally signed by the digital-content service with a digital signature, as described above with reference to FIG. 2. Digitally signing the license may prevent unauthorized copying and/or distributing of the license. Additionally, game-playing devices obtaining digitally signed licenses may decrypt the license before utilizing the license as a part of game play. For example, the game-playing device may be manufactured and/or configured to include a public key corresponding to the private key of the digital-content service, and the game-playing device may then use the public key to decrypt an encrypted digital signature of a received license.

At 98 method 80 includes delivering the limited-rights license to the game-playing device. At 100 method 80 includes downloading the limited-rights license onto the hard drive of the game-playing device. It is to be understood that the game-playing device is a nonlimiting example of a computing system comprising a local data-holding medium. Other computing systems may be used, as described with reference to FIG. 5. Further, the concepts described herein can be applied to virtually any type of digital content downloaded from virtually any type of removable data-holding media to virtually any type of local data-holding media without departing from the scope of this disclosure.

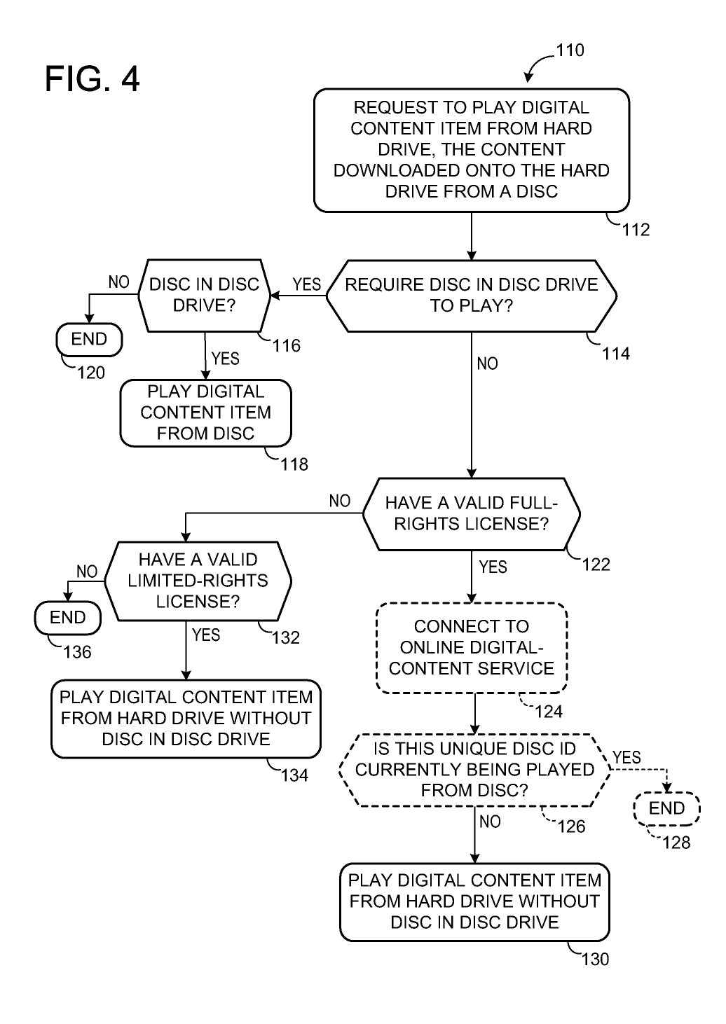

FIG. 4 shows a flow diagram of an example method 110 of playing a digital content item from a hard drive, or other local data-holding medium. At 112 method 110 includes a request to play a digital content item, such as a game, from a hard drive of a computing system, where the digital content item has been downloaded onto the hard drive from a removable data-holding medium such as a disc.

At 114 method 110 includes determining if the disc is required to be in the disc drive of the computing system in order to play the game from the hard drive. If the disc is required, then at 116 method 110 includes determining if the disc is in the disc drive. If it is determined that the disc is in the disc drive, then at 118 method 110 includes playing the game from the hard drive with the disc in the disc drive. However, if it is determined that the disc is not in the disc drive, then at 120 method 110 includes ending the play request.

If the disc is not required to be in the disc drive, then at 122 method 110 includes determining if the computing system has a valid full-rights license. If the computing system does have a valid full-rights license, then upon accessing the full-rights license for the game, the computing system may determine that the full-rights license is digitally signed with a digital signature encrypted with a private key. In such a case, the computing system may decrypt the digital signature with a public key, where the public key may be on the game-playing device, and the public key is associated with the private key of the game-playing service.

The computing system may also verify the game on the game-playing device is secure based on the full-rights license. Such a step may include verifying equivalence of a root hash hashed from the game on the hard drive and a known root hash obtained from the full-rights license and generated from a secure version of the game. Such a step ensures that the game downloaded to the hard drive is secure and corresponds to the secure version of the game for which the license was issued.

At 124 method 110 may optionally include connecting to the network-accessible digital-content service. Upon doing so, at 126 method 110 includes determining if a game with the unique disc ID is currently being played from disc. For example, a game manufacturer may want to prevent a user from downloading the game to a hard drive of his game-playing device, obtaining the full-rights license, and then giving the disc to another user for playing the game from the game disc. (i.e. prevent two concurrent game sessions from a game of a unique disc ID). For example, in the context of a game-playing experience, such a step may include sending a usage request to the gaming service, where the usage request requests the gaming service to verify another game-playing device is not playing the game from the game disc and/or has not played the game from the game disc within a predetermined time period.

If it is determined that another user is already playing the game from the game disc and/or has recently played the game from the game disc, the digital-content service may choose to prohibit the user from proceeding with playing the game from the hard drive of his game-playing system with his full-rights license, and accordingly ending his play request at 128 of method 110 and/or requiring the disc be present before game play is allowed.

However, if it is determined that another user is not already playing the game from the game disc, then the game play request proceeds as follows.

At 130 method 110 includes playing the game from the hard drive without the disc in the disc drive upon determining there is a valid full-rights license.

If it is determined at 122 that there is not a valid full-rights license, then at 132 method 110 includes determining if there is a limited-rights license. If it is determined that there is a limited-rights license, then the limited-rights license may then be verified by comparing the root hash of the game to the known root hash obtained from the limited-rights license, as described above in the case of the full-rights license. In the case that the limited-rights license grants permission for a fixed-duration trial period, license verification may also include verifying a current date of the current game play request falls within the fixed-duration trial period.

At 134 method 110 includes playing the game from the hard drive without the disc in the disc drive upon determining there is a valid limited-rights license. However, if it is determined that there is not a valid limited-rights license, then the play request ends at 136 of method 110 unless the game disc is present.

In some embodiments, the above described methods and processes may be tied to a computing system. As an example, FIG. 5 schematically shows a gaming system 150 including a computing system 152 configured to interact with a network-accessible digital-content service 154 via network 156. As described above as a nonlimiting example, computing system 152 may be a game-playing device and digital-content service 154 may be a gaming service.

Computing system 152 may perform one or more of the above described methods and processes. Computing system 152 includes a logic subsystem 158 and a data-holding subsystem 160. As shown, computing system 152 may include controller 162 configured to interact with computing system 152 as a user input device. It is to be understood that virtually any user input devices may be used, including, but not limited to, visual tracking cameras and/or acceleration/gyroscopic controllers. Computing system 152 may optionally include a display subsystem 166 and/or other components not shown in FIG. 5.

Logic subsystem 158 may include one or more physical devices configured to execute one or more instructions. Logic subsystem 158 may be used to implement an installation module 161 for performing installations to data-holding subsystem 160 and/or a determination module 163 for determining license availability. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments. Network-accessible digital-content service 154 may include a logic subsystem 165 including one or more physical devices configured to execute one or more instructions, such as described above.

Data-holding subsystem 160 may include one or more physical devices configured to hold data and/or instructions executable by the logic subsystem to implement the herein described methods and processes. When such methods and processes are implemented, the state of data-holding subsystem 160 may be transformed (e.g., to hold different data). Data-holding subsystem 160 may include removable media and/or built-in devices. Data-holding subsystem 160 may include optical memory devices, semiconductor memory devices, and/or magnetic memory devices, among others. Data-holding subsystem 160 may include devices with one or more of the following characteristics: volatile, nonvolatile, dynamic, static, read/write, read-only, random access, sequential access, location addressable, file addressable, and content addressable. In some embodiments, logic subsystem 158 and data-holding subsystem 160 may be integrated into one or more common devices, such as an application specific integrated circuit or a system on a chip.

FIG. 5 also shows an aspect of the data-holding subsystem in the form of computer-readable removable media 164, which may be used to store and/or transfer data and/or instructions executable to implement the herein described methods and processes.

When included, display subsystem 166 may be used to present a visual representation of data held by data-holding subsystem 160. As the herein described methods and processes change the data held by the data-holding subsystem, and thus transform the state of the data-holding subsystem, the state of display subsystem 166 may likewise be transformed to visually represent changes in the underlying data. Display subsystem 166 may include one or more display devices utilizing virtually any type of technology. Such display devices may be combined with logic subsystem 158 and/or data-holding subsystem 160 in a shared enclosure, or such display devices may be peripheral display devices.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of playing a digital content item, the method comprising:
downloading the digital content item from a removable data-holding medium to a local data-holding medium of a media playing system;
sending a licensing request to a network-accessible, digital-content service;
receiving a full-rights license for the digital content item from the digital-content service, the full-rights license granting a right to play the digital content item from the local data-holding medium of the media playing system without the removable data-holding medium being present;
receiving a request to play the digital content item;
verifying the full-rights license for the digital content item; and
playing the digital content item from the local data-holding medium if the full-rights license verifies.

2. The method of claim 1, where the removable data-holding medium is a game disc and the media playing system is a game-playing device.

3. The method of claim 1, where the licensing request requests the digital-content service to grant the full-rights license, the licensing request including information identifying a user of the media playing system, the digital content item, and the removable data-holding medium from which the digital content item was downloaded.

4. The method of claim 3, where the licensing request includes a user ID identifying a user of the media playing system, a device ID identifying the media playing system, an item ID identifying the digital content item, a version ID identifying a version of the digital content item, and a unique removable medium ID identifying the removable data-holding medium, each removable data-holding medium having a unique removable medium ID different from other unique removable medium IDs of other removable data-holding media.

5. The method of claim 4, where the unique removable medium ID is on the removable data-holding medium and the media playing system is configured to automatically read the unique removable medium ID off of the removable data-holding medium.

6. The method of claim 1, where sending the licensing request includes sending a unique removable medium ID identifying the removable data-holding medium, where each removable data-holding medium has a unique removable medium ID different from other unique removable medium IDs of other removable data-holding media, so the digital-content service is able to determine if the full-rights license has already been granted for the unique removable medium ID.

7. The method of claim 1, where verifying the full-rights license includes performing a security check to determine that the digital content item is secure.

8. The method of claim 7, further comprising verifying equivalence of a root hash hashed from the digital content item on the local data-holding medium and a known root hash generated from a secure version of the digital content item.

9. The method of claim 1, where verifying the full-rights license includes sending a usage request to the digital-content service, the usage request requesting the digital-content service to verify that another local data-holding medium is not playing the digital content item from the removable data-holding medium.

10. The method of claim 1, where the full-rights license is digitally signed with a digital signature, the digital signature encrypted with a private key.

11. The method of claim 10, where verifying the full-rights license for the digital content item includes decrypting the digital signature with a public key on the media playing system, the public key corresponding to the private key used to encrypt the full-rights license.

12. A game-playing device comprising:
a logic subsystem;
a data-holding subsystem holding instructions executable by the logic subsystem to:
download a game from a game disc to the data-holding subsystem;
send a licensing request to a network-accessible gaming service, the licensing request including a user ID identifying a user of the game-playing device, a device ID identifying the game-playing device, a game ID identifying the game, a version ID identifying a version of the game, and a unique disc ID identifying the game disc, each game disc having a unique disc ID different from other unique disc IDs of other game discs;
receive a full-rights license for the game from the game-playing service, the full-rights license granting a right to play the game from the data-holding subsystem of the game-playing device without the game disc being present and the full-rights license digitally signed with a digital signature encrypted by a private key corresponding to the game-playing service;
receive a request to play the game;
access the full-rights license for the game;
decrypt the digital signature with a public key associated with the private key of the game-playing service;
verify the game on the game-playing device is secure based on the full-rights license; and
play the game from the data-holding subsystem if the full-rights license verifies.

13. The device of claim 12, where the unique disc ID is on the game disc and the game-playing device is further configured to automatically read the unique disc ID off of the game disc.

14. The device of claim 12, where the instructions are further executable to verify the full-rights license is secure by verifying equivalence of a root hash hashed from the game on the data-holding subsystem and a known root hash generated from a secure version of the game.

15. The device of claim 12, where the instructions are further executable to verify the full-rights license is secure by sending a usage request to the gaming service, the usage request requesting the gaming service to verify another game-playing device is not playing the game from the game disc.

16. A gaming system, comprising:
one or more networked game-playing devices, each game-playing device including a local data-storage medium and a drive configured to read a game medium;
a network-accessible gaming service configured to:
receive a licensing request from one of the networked game-playing devices, the licensing request including information associated with a game installed from a game medium to the local data-storage medium of that game-playing device;
verify that a full-rights license can be granted for the game;
create the full-rights license, the full-rights license granting a right for the game-playing device from which the request was received to play the game from the local data-storage medium of that game-playing device without the game medium being present; and
send the full-rights license to that game-playing device.

17. The system of claim 16, where the licensing request includes a device ID identifying the game-playing device from which the licensing request was received, a user ID identifying a user of that game-playing device, a game ID identifying the game, a version ID identifying a version of the game, and a unique disc ID identifying the game medium, each game medium having a unique disc ID different from other unique disc IDs of other game media.

18. The system of claim 17, where the unique disc ID is on the game medium and the game-playing device is configured to automatically read the unique disc ID off of the game medium.

19. The system of claim 17, where the gaming service is configured to verify that the full-rights license can be granted for the game medium by receiving a unique disc ID identifying the game medium, where each game medium has a unique disc ID different from other unique disc IDs of other game media, and determining if the full-rights license has already been granted for the unique disc ID.

20. The system of claim 17, where the gaming service is configured to verify that the full-rights license can be granted by verifying equivalence of a known root hash generated from a secure version of the game and a root hash hashed from the game on the local data-storage medium.
